(19) United States
(12) Patent Application Publication
(10) Pub. No.: US 2011/0031861 A1
(43) Pub. Date: Feb. 10, 2011

(54) CRYOGENIC INSULATION ATTACHMENT

(75) Inventors: Matthew C. Gentry, Katy, TX (US); Stuart L. Wilson, Pearland, TX (US)

Correspondence Address: ConocoPhillips Company - IP Services Group;Attention: DOCKETING, 600 N. Dairy Ashford, Bldg. MA-1135, Houston, TX, 77079, US

(73) Assignee: CONOCOPHILLIPS COMPANY, Houston, TX (US)

(21) Appl. No.: 12/848,478

(22) Filed: Aug. 2, 2010

Related U.S. Application Data
(60) Provisional application No. 61/232,214, filed on Aug. 7, 2009.

(51) Int. Cl. F25D 23/06; B23P 15/26

(52) U.S. Cl. 312/406; 29/890.035

(57) ABSTRACT

An attachment means of insulation within a container to prevent heat leakage from the ambient to an apparatus located within the container that operates at a cryogenic temperature.

### CROSS-REFERENCE TO RELATED APPLICATIONS

This application claims priority benefit under 35 U.S.C. Section 119(e) to U.S. Provisional Patent Ser. No. 61/232,214 filed on Aug. 7, 2009 the entire disclosure of which is incorporated herein by reference.

### FIELD OF THE INVENTION

The present invention relates to an attachment of insulation to insulate an apparatus operating at cryogenic temperature within a container from heat leakage through the container walls.

### BACKGROUND OF THE INVENTION

In many industrial applications, an apparatus that is designed to operate at cryogenic temperatures is located within an insulated container to minimize heat leakage from the ambient to the apparatus.

An example of an apparatus that has operational temperature requirements is a cryogenic distillation apparatus in which air is compressed, purified and then cooled to a temperature at or near its dew point for distillation in one or more distillation columns to separate lighter components such as nitrogen and argon from heavier components such as oxygen. The incoming air is cooled against product streams such as nitrogen and oxygen within a main heat exchanger.

Another example is a device for liquefying natural gas whereby gas from a high pressure pipeline is expanded, cooled and condensed to produce a liquefied natural gas (LNG) product.

In order to maintain the low temperatures required for such cryogenic operations, the equipment can be placed within a container known as a cold box. Such a container operates at a positive pressure, that is, the container is not sealed to the ambient. Bulk fill insulation, ordinarily in particulate form is introduced into the container to provide insulation. Such bulk fill insulation, for example perlite, inhibits both convective and radiative heat transfer and constrains the heat transfer occurring through conduction.

Another type of insulation that has been proposed for use in connection with cryogenic equipment is aerogel insulation. Aerogels have the advantage of having a lower thermal conductivity than traditional insulation materials such as perlite. Aerogels are water-free gels that are dried such that the solid matter of the gel remains intact to produce an open cell structure which can include inorganic aerogels that are formed of silica, alumina, zirconia, tungsten and titanium. Additionally, organic aerogels such as resorcinol-formaldehyde aerogels have also been formed. Aerogels can be formed as a solid block of material, as a fine powder, or as pellets. Aerogel materials can also be used as fill for a blanket or mixed and strengthened with fibers to form a blanket-like or mat-like structure.

A minimum insulation thickness is required to prevent excessive heat leakage, which will result in local ice spots from forming on the surface of the container. The container is fabricated from carbon steel material not suitable for exposure to cryogenic temperatures. A minimum insulation thickness is also required to avoid brittle failure of the container walls and structural supports. As can be appreciated, the lower the thermal conductivity of the insulation, the smaller the minimum thickness of insulation, and the smaller the container because less insulation would be required.

Manipulation of aerogels, one of the best known insulators, can be very challenging given the fragility of this material form. The development of fiber-reinforced aerogels has yielded a more adaptable aerogel composite form with improved mechanical properties such as conformability and flexibility without any substantial loss of thermal insulation performance. However, few methodologies have yet been developed for securing or attaching these fiber reinforced forms. For instance, most adhesives do not perform well and ultimately fail at cryogenic temperatures such as those encountered by insulation systems in liquid natural gas (LNG) pipelines. At high operating temperatures, many adhesives tend to burn off, plastic tags can melt and stitchings may fail. Furthermore, attaching panels or blankets to the walls, floor and ceiling is an important design aspect in that the method should be extremely reliable and not affect the thermal performance of the box unduly. For these and various other reasons it is clear that a need exists for securing methods of the fiber-reinforced aerogels.

### SUMMARY OF THE INVENTION

The present invention provides a method of affixing an attachment means for insulating an apparatus capable of operating at cryogenic temperatures or an apparatus able to contain equipment capable of operating at cryogenic temperatures, the method comprises: placing an insulation means in the interior surface of the apparatus at a desired location, wherein the insulation means is removable, wherein the insulation means includes a thermal insulation panel, wherein the thermal insulation panel is made of a material capable of preventing heat leakage, wherein the thermal insulation panel includes an interior surface which is the surface directly connected to the apparatus and a exterior surface, wherein the thermal insulation panel is aerogel and a plug cut from the thermal insulation panel, wherein the plug is the exact size of an attachment means; and placing the attachment means in the plug cut from the thermal insulation panel thereby affixing the insulation means to the interior face of the apparatus, wherein the attachment means is removable, wherein the attachment means is a magnetic attachment, wherein the plug or series of plugs are reattached on top of the attachment means.

In another embodiment of the present invention, an insulation means for insulating an apparatus capable of operating at cryogenic temperatures or able to contain equipment capable of operating at cryogenic temperatures, the insulation means comprising: a thermal insulation panel, wherein the thermal insulation panel is made of a material capable of preventing heat leakage from the apparatus, wherein the thermal insulation panel includes an interior surface and an exterior surface; and a plug cut from the thermal insulation panel, wherein the plug is cut to allow for placement of an attachment to affix the thermal insulation panel in place, wherein the plug is the exact size of the securing mechanism.

### BRIEF DESCRIPTION OF THE DRAWINGS

The invention, together with further advantages thereof, may best be understood by reference to the following description taken in conjunction with the accompanying drawings in which:

FIG. 1 is a schematic representation of an insulation arrangement and attachment in accordance with the preset invention.

FIG. 2 is a magnified illustration of a portion of the insulation arrangement and attachment in accordance with the present invention.

FIG. 3 is an additional embodiment of the arrangement and attachment means in accordance with the present invention.

### DETAILED DESCRIPTION OF THE INVENTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variation can be made in the present invention without departing from the scope or spirit of the invention. For instances, features illustrated or described as part of one embodiment can be used on another embodiment to yield a still further embodiment. Thus, it is intended that the present invention cover such modifications and variations that come within the scope of the appended claims and their equivalents.

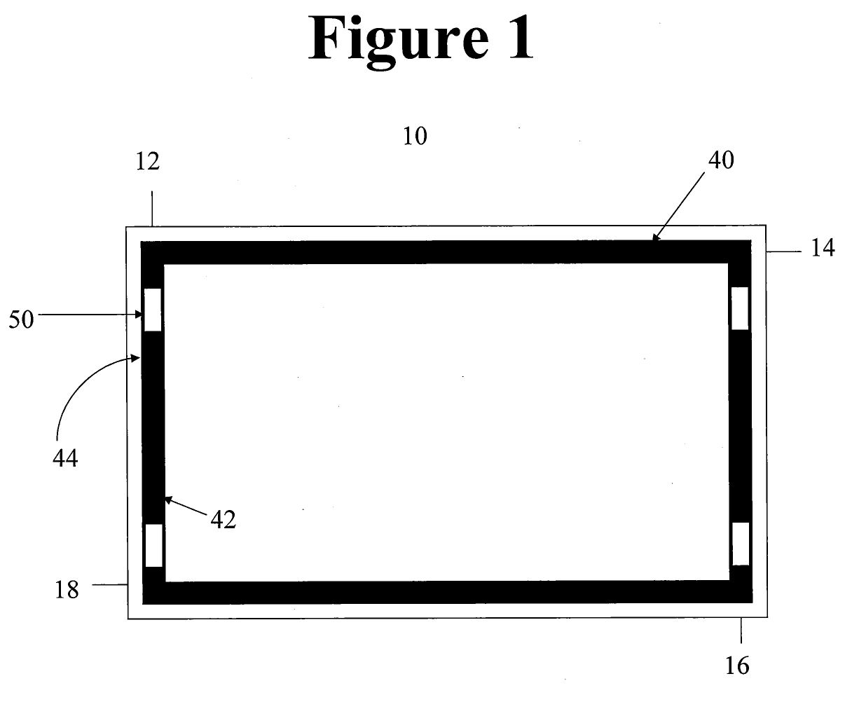

With reference to FIG. 1, a container 10 is illustrated that is of rectangular transverse cross-section with four connected walls 12, 14, 16 and 18. Container 10 can serve the function as a thermal insulator capable of containing equipment operating at cryogenic temperatures. For instance, container 10 could be a cold box. Additionally, container 10 may contain several pieces of equipment, such as heat exchanger and/or distillation column(s).

For instance, located within container 10 is an apparatus designed to operate at cryogenic temperatures. The apparatus could be a distillation column of an air separation unit in which air is rectified to cryogenic temperatures. It is to be noted that in such apparatus, air is cooled to at or near its dew point and then introduced into a distillation column in which an ascending vapor phase containing the lighter components of the air, for example, nitrogen, is in part liquefied at the column to reflux the column with liquid. The descending liquid phase contacts the ascending vapor phase through a contact element such as structured packing or sieve trays to produce mass transfer between the phases. As a result the ascending vapor becomes evermore rich in the lighter components such as nitrogen than the descending liquid phase evermore rich as it descends with oxygen.

In another embodiment, a heat exchanger is used to cool the air being distilled in a cryogenic distillation column. However, it also operates at a higher temperature being that it is cooling the incoming air. Thus, in the cold box or container 10, there exists heat leakage from the ambient through the container walls 12, 14, 16 and 18 and also potentially heat leakage from the heat exchanger to the distillation column.

In order to reduce heat leakage from the ambient through the container wall to the items contained within the container, affixing an insulation means to the interior walls of container 10 is provided in accordance with the present invention. The arrangement of insulation consists of a thermal insulation panel or sheet 40 made of a material capable of preventing heat leakage, for instance aerogel. The thermal insulation panel or sheet is capable of being directly affixed to the interior walls of the cold box or to the exterior walls of the cold box, whichever is preferred and most effective. Furthermore, the size and thickness of the thermal insulation is a function of the size of the cold box and the associated heat leakage. As shown in FIG. 1, the thermal insulation panel or sheet 40 includes an interior surface 42 and an exterior surface 44, whereby the interior surface 42 is directly connected to the interior surface of container 10.

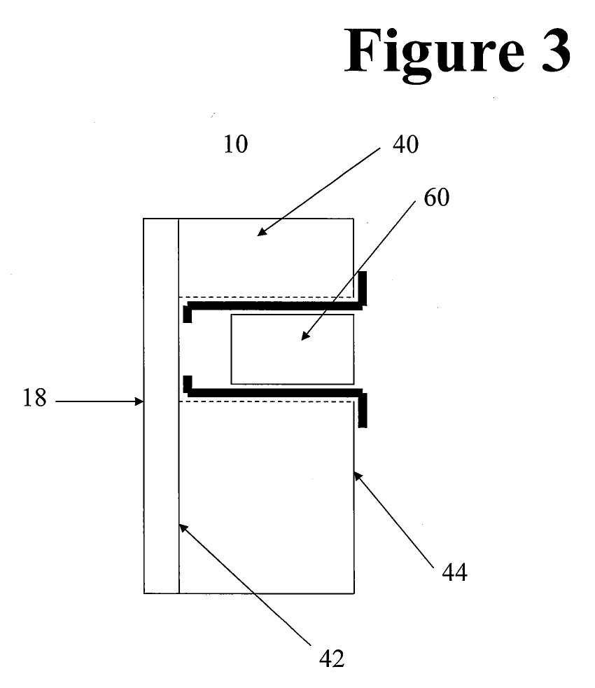

The attachment means 50 should securely and reliably allow fixation of the insulation panel or sheet onto the walls of the container through a plug or series of plugs cut from the insulation, discussed in detail below. Furthermore, attachment means 50 should eliminate any convection that might negatively affect the skin or structural members of container 10. In an embodiment, the attachment means is a magnetic piece. In another embodiment, the attachment means is a magnetic strip. In another embodiment, as shown in FIG. 3, a bracket of low heat transfer coefficient material is used to provide more support to the insulating panel or sheet.

A suitable attachment, for example, would be a magnetic attachment made from a ferromagnetic material. The term ferromagnetic material as used herein designates all types of metals and metal alloys which can be magnetized and/or attracted by a magnet, e.g. iron. The term magnetized support as used herein designates any support being capable of fixating a ferromagnetic metal, i.e. a support comprising one or more magnets. The magnetic force of the magnetized support can be provided by any means such as any number of static- and/or electromagnets.

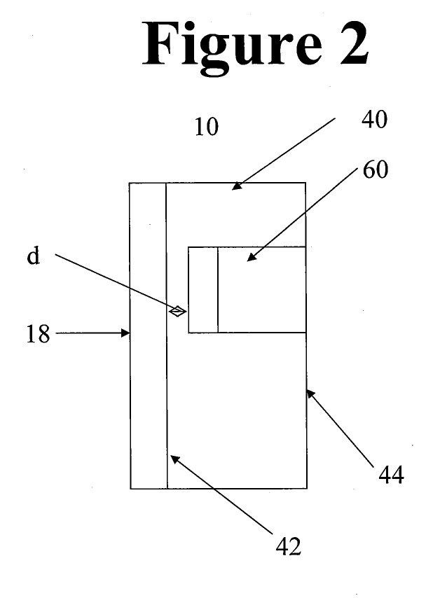

Referring to FIG. 2, a plug or series of plugs 60 are cut from thermal insulation panel or sheet. The plugs are cut to the exact size of an attachment means. In an embodiment, the plug or series of plugs may be cut partially through the insulation panel or sheet thickness in order to accommodate the attachment means. In another embodiment, the plug or series of plugs may be cut entirely through the insulation panel or sheet thickness in order to accommodate the attachment means. The distance d is measured from the interior surface of the insulating panel or sheet to the bottom of the hole cut for plug 60. Distance d is a function of the magnetic material selected and the holding force required of each individual magnetic attachment.

In practice, the thermal insulation panel or sheet is affixed at a desired location on the cold box. The insulation is attached to the walls, the floor and/or the roof of the cold box. Additionally, the insulation can be affixed to the interior surface or the exterior surface of the cold box. Prior to placement, the thermal insulation panel or sheet contains a plug or series of plugs at a desired location. The attachment means are then placed in the plug cut outs to properly secure the thermal insulation in place. The plug cut outs are then re-affixed on top of the attachment means.

The preferred embodiment of the present invention has been disclosed and illustrated. However, the invention is intended to be as broad as defined in the claims below. Those skilled in the art may be able to study the preferred embodiments and identify other ways to practice the invention that are not exactly as described in the present invention. It is the intent of the inventors that variations and equivalents of the invention are within the scope of the claims below and the description, abstract and drawings not to be used to limit the scope of the invention.

1. A method of affixing an attachment means for insulating an apparatus capable of operating at cryogenic temperatures or able to contain equipment capable of operating at cryogenic temperatures, said method comprising:
a. placing an insulation means in the interior surface of said apparatus at a desired location, wherein said insulation means is removable, wherein said insulation means includes:
i. a thermal insulation panel, wherein said thermal insulation panel is made of a material capable of preventing heat leakage, wherein said thermal insulation panel includes an interior surface which is the surface directly connected to said apparatus and a exterior surface, wherein said thermal insulation panel is aerogel,
ii. a plug or series of plugs cut from said thermal insulation panel, wherein said plug is the exact size of an attachment means; and
b. placing said attachment means in said plug or series of plugs cut from said thermal insulation panel thereby affixing said insulation means to said interior face of said apparatus, wherein said attachment means is removable, wherein said attachment means is a magnetic attachment, wherein said plug or series of plugs are reattached on top of said attachment means.

2. The method according to claim 1, wherein said apparatus is a cold box.

3. The method according to claim 1, wherein said magnetic attachment is disposed within said plug cut from said panel located on the exterior face of said insulation means.

4. The method according to claim 1, wherein said magnetic attachment is disposed within said plug cut from said panel located on the interior face of said insulation means.

5. The method according to claim 1, wherein said plug or series of plugs are cut partially through said thermal insulation panel to accommodate said attachment means.

6. The method according to claim 1, wherein said plug or series of plugs are cut entirely through said thermal insulation panel to accommodate said attachment means.

7. The method according to claim 1, wherein said attachment means are spaced to provide adequate support to said thermal insulation panel.

8. The method according to claim 1, wherein said attachment means further includes a bracket of low heat transfer coefficient material to provide additional support to said thermal insulation panel.

9. An insulation means for insulating an apparatus capable of operating at cryogenic temperatures or able to contain equipment capable of operating at cryogenic temperatures, said insulation means comprising:
a. a thermal insulation panel, wherein said thermal insulation panel is made of a material capable of preventing heat leakage from said apparatus, wherein said thermal insulation panel includes an interior surface and an exterior surface; and
b. a plug cut from said thermal insulation panel, wherein said plug is cut to allow for placement of an attachment to affix said thermal insulation panel in place, wherein said plug is the exact size of said securing mechanism.

10. The insulation means according to claim 9, wherein said plug cut from said panel is located on the exterior face of said insulation means.

11. The insulation means according to claim 9, wherein said plug cut from said panel is located on the interior face of said insulation means.

12. The insulation means according to claim 9, wherein said apparatus capable of operating at cryogenic temperatures is a cold box.

13. The insulation means according to claim 9, wherein said thermal insulation panel is affixed to the interior surface of said cold box.

14. The insulation means according to claim 9, wherein said thermal insulation panel is perlite.

15. The insulation means according to claim 9, wherein said thermal insulation panel is aerogel.

16. The insulation means according to claim 9, wherein said securing mechanism is a magnetic attachment.

17. The method according to claim 9, wherein said plug or series of plugs are cut partially through said thermal insulation panel to accommodate said attachment means.

18. The method according to claim 9, wherein said plug or series of plugs are cut entirely through said thermal insulation panel to accommodate said attachment means.

19. The method according to claim 9, wherein said attachment means are spaced to provide adequate support to said thermal insulation panel.

20. The method according to claim 9, wherein said attachment means further includes a bracket of low heat transfer coefficient material to provide additional support to said thermal insulation panel.

21. The method according to claim 9, wherein said plug or series of plugs are reattached to said thermal insulation panel on top of said attachment means.

22. A method of affixing an attachment means for insulating an apparatus capable of operating at cryogenic temperatures or able to contain equipment capable of operating at cryogenic temperatures, said method comprising:
a. Placing an insulation means in the interior surface of said apparatus at a desired location, wherein said insulation means includes:
i. A thermal insulation panel, wherein said thermal insulation panel includes an interior surface which is the surface directly connected to said apparatus and a exterior surface,
ii. A plug cut of said thermal insulation panel, wherein said plug is the exact size of said attachment means; and
b. Placing said attachment means in said plug cut from said thermal insulation panel thereby affixing said insulation means to said interior face of said apparatus, wherein said attachment means is a magnetic attachment.

23. The method according to claim 22 wherein said apparatus capable of operating at cryogenic temperatures is a cold box.

24. The method according to claim 22, wherein said insulation means is removable.

25. The method according to claim 22, wherein said attachment means is removable.

26. The method according to claim 22, wherein said magnetic attachment is disposed within said plug cut from said panel located on the exterior face of said insulation means.

27. The method according to claim 22, wherein said magnetic attachment is disposed within said plug cut from said panel located on the interior face of said insulation means.

28. The method according to claim 22, wherein said thermal insulation panel is perlite.

29. The method according to claim 22, wherein said thermal insulation panel is aerogel.

30. The method according to claim 22, wherein said plug or series of plugs are cut partially through said thermal insulation panel to accommodate said attachment means.

31. The method according to claim 22, wherein said plug or series of plugs are cut entirely through said thermal insulation panel to accommodate said attachment means.

32. The method according to claim 22, wherein said attachment means are spaced to provide adequate support to said thermal insulation panel.

33. The method according to claim 22, wherein said attachment means further includes a bracket of low heat transfer coefficient material to provide additional support to said thermal insulation panel.

34. The method according to claim 22, wherein said plug or series of plugs are reattached to said thermal insulation panel on top of said attachment means.
